(19) United States
(12) Patent Application Publication
(10) Pub. No.: US 2008/0122238 A1
(43) Pub. Date: May 29, 2008

(54) Truck bed animal enclosure device

(76) Inventor: Terry M. Fulmer, Bonita Springs, FL (US)

Correspondence Address: EDWARD M. LIVINGSTON, PA, 963 TRAIL TERRACE DRIVE, NAPLES, FL, 34103, US

(21) Appl. No.: 11/605,718

(22) Filed: Nov. 28, 2006

(51) Int. Cl. B62D 33/04

(52) U.S. Cl. 296/24.31

(57) ABSTRACT

A truck bed animal enclosure device (1) comprising a frame (2) having a top section (3), two side sections (4) and a back section (5). The top section (3) covers a substantial portion of a truck bed (15). The side sections (4) extend above the truck bed side panels (16) and are secured to the top section (3). The back section (5) is extends above a truck bed tailgate (28) and is pivotally secured to the top section (3) via a hinging means (12) so as to permit a user to raise the back section (5). The side sections (4) include at least one aperture (31) so as to permit cross-ventilation within the truck bed (15). A covering means (6) is secured over the top section (3) so as to provide shade and shelter to the interior of the truck bed (15).

### BACKGROUND OF THE INVENTION

This invention relates to animal enclosure devices, more particularly, an animal enclosure device that is securable to a truck bed so as to enclose an animal within the confines of the truck bed.

Many people, particularly hunters, travel with their dog(s) to different locations by placing the dog(s) in a pickup truck bed. Although it is convenient for the owner to place the dog(s) in the truck bed due to lack of space within the truck cab or if the dog(s) is dirty or wet, it is often dangerous to do so as the truck bed is not completely enclosed. Although many dog(s) are trained to stay within the truck bed, there is always a possibility of the dog jumping or falling from the truck bed while the vehicle is moving, thus injuring or even possibly killing itself.

Several methods and devices have been used to increase the safety of the dogs when they are traveling in the truck bed. For example, some owners tether the dog to the interior of the truck bed. However, the dog may still attempt to jump from the truck bed, thereby hanging itself. In addition, when the dog is tethered to the interior of the truck bed, the dog is still exposed to the elements of nature, including the sun and rain.

In the alternative, some owners utilize cages so as to enclose the dog within the cage. However, the dog usually does not have much room to move within the kennel, thereby being a poor choice for longer road trips. Moreover, the use of cages severely limit the amount of fresh air that the dog is exposed to and limits the amount of cross-ventilation, thereby making the interior of the cage very warm.

In addition, other live animals may be placed within the truck bed wherein the owner is concerned with maintaining the animal in a safe condition.

Thus, there exists the need for a truck bed animal enclosure that safely confines the animal(s) within the truck bed while permitting the animal(s) to move within the truck bed, permitting adequate cross-ventilation and protecting the animal(s) from the elements of nature.

The relevant prior art includes the following patents:

| Patent No. | | |
|---|---|---|
| (U.S. unless | | |
| stated otherwise) | Inventor | Issue/Publication Date |
| 6,725,807 | Tapia | Apr. 27, 2004 |
| 6,499,434 | Tyler | Dec. 31, 2002 |
| 6,276,736 | Cook et al. | Aug. 21, 2001 |
| 5,887,932 | Pier, II. | Mar. 30, 1999 |
| 5,524,573 | Hart | Jun. 11, 1996 |
| 5,147,103 | Ducote | Sep. 15, 1992 |
| 5,144,910 | Darby | Sep. 08, 1992 |
| 5,065,699 | Marshall | Nov. 19, 1991 |
| 4,803,951 | Davis | Feb. 14, 1989 |
| 4,546,728 | May | Oct. 15, 1985 |
| 3,773,017 | Johannes | Nov. 20, 1973 |
| Des. 414,302 | Potestio | Sep. 21, 1999 |
| Des. 403,129 | Mentz | Dec. 22, 1998 |
| Des. 398,423 | Mentz | Sep. 15, 1998 |
| Des. 360,491 | Campbell | Jul. 18, 1995 |
| Des. 346,676 | Hopper, Jr. et al. | May 03, 1994 |
| Des. 334,444 | Darby | Mar. 30, 1993 |
| Des. 330,443 | Darby | Oct. 20, 1992 |
| Des. 330,274 | Smith et al. | Oct. 13, 1992 |

### SUMMARY OF THE INVENTION

The primary object of the present invention is to provide a truck bed animal enclosure device that securely confines animals within a truck bed.

A further object of the present invention is to provide a truck bed animal enclosure device that provides cross-ventilation for animals housed within a truck bed.

An even further object of the present invention is to provide a truck bed animal enclosure device that protects the animals from the elements when housed within a truck bed.

A further object of the present invention is to provide a truck bed animal enclosure device that is easily securable to a truck bed.

An even further object of the present invention is to provide a truck bed animal enclosure device that is easy to use.

An even further object of the present invention is to provide a truck bed animal enclosure device that is durable.

Another object of the present invention is to provide a truck bed animal enclosure device that may be used on a variety of pickup trucks.

The present invention fulfills the above and other objects by providing a truck bed animal enclosure device comprising a frame having a top section, two side sections and a back section. The top section is sized and shaped so as to cover a substantial portion of the truck bed and is preferably positioned against a back of the truck cab. The side sections are sized and shaped so as to extend above the side panels of a truck bed a predetermined distance and are secured to the top section. The back section is sized and shaped so as to extend above a truck bed tailgate the same predetermined distance as the side sections and is pivotally secured to the top section via a hinging means so as to permit a user to raise the back section. Thus, a predetermined area within the truck bed is formed having the same length and width of the truck bed, but a height greater than the side panels of the truck bed. The side sections include at least one aperture so as to permit cross-ventilation within the truck bed. A locking means may be included on the back section so as to lock the back section to the side sections. Fastening means, which are preferably clamps, are used to secure the side sections of the frame to the sides of the truck bed. In this manner, the present invention may be used on a variety of pickup trucks as the frame is not inserted into a portion of the truck bed side panels. However, additional fastening means, such as clips, inserts, dowels or any other means may also be used. A covering means, such as a tarp, is secured over the top section of the frame so as to provide shade and shelter to the truck bed located therebeneath. In the alternative, the top section may be constructed of a solid piece such that the top section itself provides shade and shelter, thus not necessitating a covering means.

To use the present invention, a user positions the frame of the truck bed animal enclosure of the present invention on top of the side panels of a truck bed such that the top section of the frame is located above the truck bed and the back section of the frame is located above the tailgate of the truck bed. The user then secures the frame via fastening means, which may be clamps, clips, inserts, dowels or any other means, such that the frame is securely attached to the truck bed side panels. Then, the user lowers the tailgate, raises the back section and permits the animals to jump into the truck bed or places the animals within the truck bed. The user then closes the tailgate, lowers the back section and locks the back section so as to maintain the animals within the confines of the truck bed.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the truck bed animal enclosure device of the present invention installed on a truck;

FIG. 2 is a side view of the truck bed animal enclosure device of the present invention installed on a truck;

FIG. 3 is a plan rear view of the embodiment of FIG. 2;

FIG. 4 is a rear view of the truck bed animal enclosure device present invention in an open position;

FIG. 5 is a side interior view of the truck bed animal enclosure device of the present invention installed on a truck bed;

FIG. 6 is a side view of a means for fastening the truck bed animal enclosure device of the present invention on a truck bed;

FIG. 7 is an upward interior view of the truck bed animal enclosure device of the present invention;

FIG. 8 is a top view of the truck bed animal enclosure device of the present invention;

FIG. 9 is a side plan view of an alternate embodiment of the truck bed animal enclosure device of the present invention; and

FIG. 10 is a side plan view of a frame of the truck bed animal enclosure device of the present invention having an optional water feature.

### DESCRIPTION OF THE PREFERRED EMBODIMENTS

For purposes of describing the preferred embodiment, the terminology used in reference to the numbered components in the drawings is as follows:
1. truck bed animal enclosure device, generally
2. frame
3. top section
4. side section
5. back section
6. covering
7. vertical bar
8. horizontal bar
9. securing means
10. fastening means
11. locking means
12. hinging means
13. clamp
14. bolt
15. truck bed
16. truck bed side panel
17. spigot
18. water drinking means
19. water
20. opening
21. cap
22. hardtop section
23. pin
24. lanyard
25. hole
26. truck
27. truck cab
28. truck bed tailgate
29. truck bed floor panel
30. truck bed front panel
31. aperture
32. curtain
33. top section first edge
34. top section second edge
35. external threads

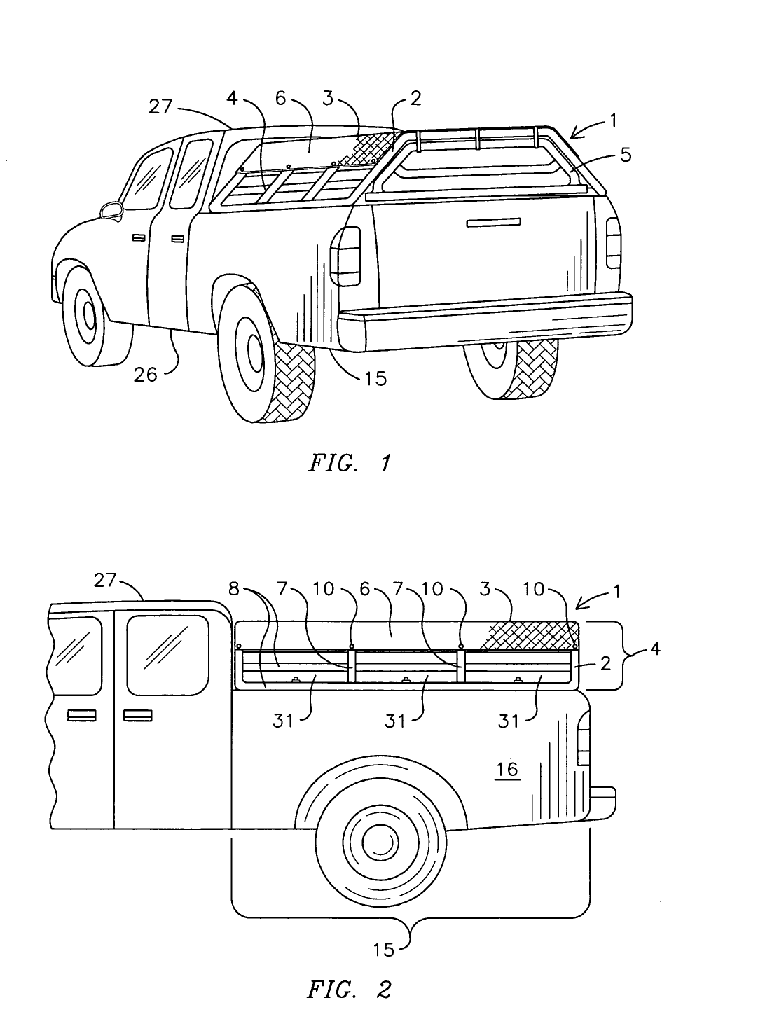

With reference to FIG. 1, a perspective view of the truck bed animal enclosure device of the present invention installed on a truck is shown. The truck bed animal enclosure device, generally 1, includes a frame 2 having a top section 3, two side sections 4 and a back section 5. A covering 6, which may be a waterproof tarp material or any other material, such as Sunbrella® cloth, is secured to the top section 3 of the frame 2 and preferably extends over a portion of the side sections 4 so as to provide a shelter from the elements of nature. The truck bed animal enclosure device 1 is secured to a truck bed 15 of a truck 26 so as to extend substantially the entire length of the truck bed 15 and adjacent to a truck cab 27. In this manner, the truck bed animal enclosure device 1 encloses animals located within the truck bed 15 in the truck bed 15.

In FIG. 2, a side view of the truck bed animal enclosure device of the present invention installed on a truck bed is shown. The truck bed animal enclosure device 1 is secured to each truck bed side panel 16 of the truck bed 15 so as to enclose the truck bed 15. The frame 2 comprises a plurality of vertical bars 7 and horizontal bars 8 made of a predetermined material, which is preferably polyvinyl chloride (PVC) pipe but may be constructed of any other material. The intersecting vertical and horizontal bars 7 and 8 form a plurality of apertures 31 that permit cross-ventilation of air over the truck bed 15 and through the truck bed animal enclosure device 1. The covering 6 extends over the top section 3 and side sections 4 of the frame, thereby shading the interior of the truck bed 15 and reducing the surface temperature of the truck bed 15.

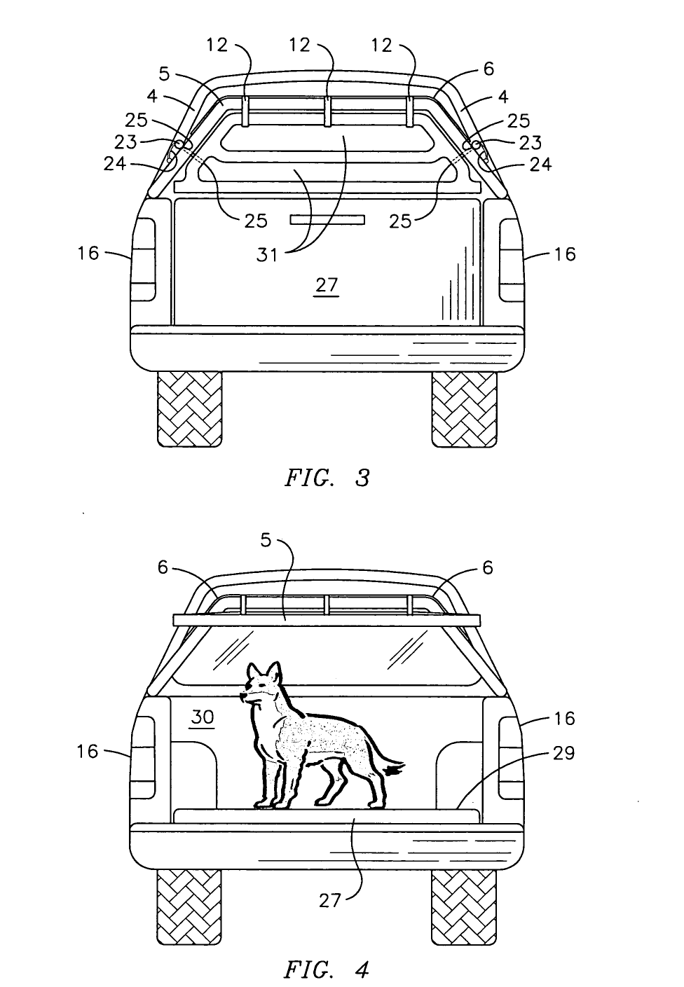

Next, FIG. 3 shows a plan rear view of the embodiment of FIG. 2. The truck bed animal enclosure device 1 is sized and shaped so as to substantially cover a length and width of a truck bed 15. The side sections 4 of the frame 2 extend a predetermined distance above the truck bed side panels 16 and the back section 5 extends a predetermined distance above the truck bed tailgate 27 so as to provide a greater volume area that is enclosed within the truck bed 15. The back section 5 is secured to the top section 3 via a hinging means 12, which is preferably at least one strap but may be traditional hinges or any other hinging means 12. A locking means 15, which is preferably a pin 23 and a lanyard 24 that is secured to the side sections 4 but may be any other locking means 15, permits a user to lock the back section 5 to the side sections 4, thereby preventing the back section 5 from opening. At least one hole 25 is located within the side sections 4 and extends into back section 5 so permit the pin 23 to lock the back section 5. The back section 5 may also include a plurality of apertures 31 so as to provide additional ventilation.

In FIG. 4, a rear view of the truck bed animal enclosure device of the present invention in an open position is shown. The back section 5 of the frame 2 is raised so as to permit loading and unloading of at least one animal within the truck bed 15. During use, the animal(s) remain on the truck bed floor panel 29 and are enclosed within the truck bed 15 as it/they are surrounded by the truck bed tailgate (27) (when closed), the truck bed side panels 16, the truck bed front panel 30, the side sections 4 and the top section 3. The side sections 4 are preferably secured to the top section 3 at an angle so as minimize the loss of field of view.

FIG. 5 shows a side interior view of the truck bed animal enclosure device of the present invention installed on a truck bed. The side sections 4 of the truck bed animal enclosure device 1 is secured to the side panels 16 via a securing means 9, which is preferably at least one clamp but may be other securing means 9, such as clips, inserts, dowels or any other means.

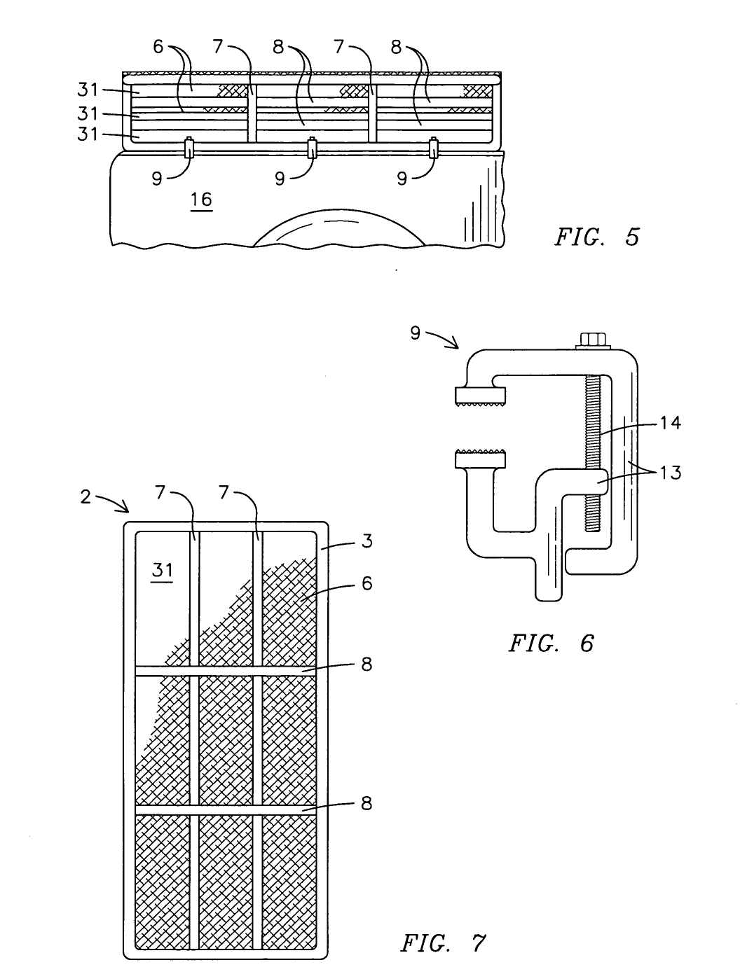

Next, FIG. 6 shows a side view of a means for fastening the truck bed animal enclosure device of the present invention on a truck bed. The fastening means 9 may be a clamp 13 and bolt 14 that permits clamping of the side sections 4 of the frame 2 to the truck bed side panels 16.

With reference to FIG. 7, an upward interior view of the truck bed animal enclosure device of the present invention is shown. The top section 3 of the frame 2 preferably comprises intersecting vertical and horizontal bars 7 and 8 that form a plurality of apertures 31. The covering 6 extends over the top section 3 so as to cover the apertures 31, thereby providing shade and protecting the interior of the truck bed 15.

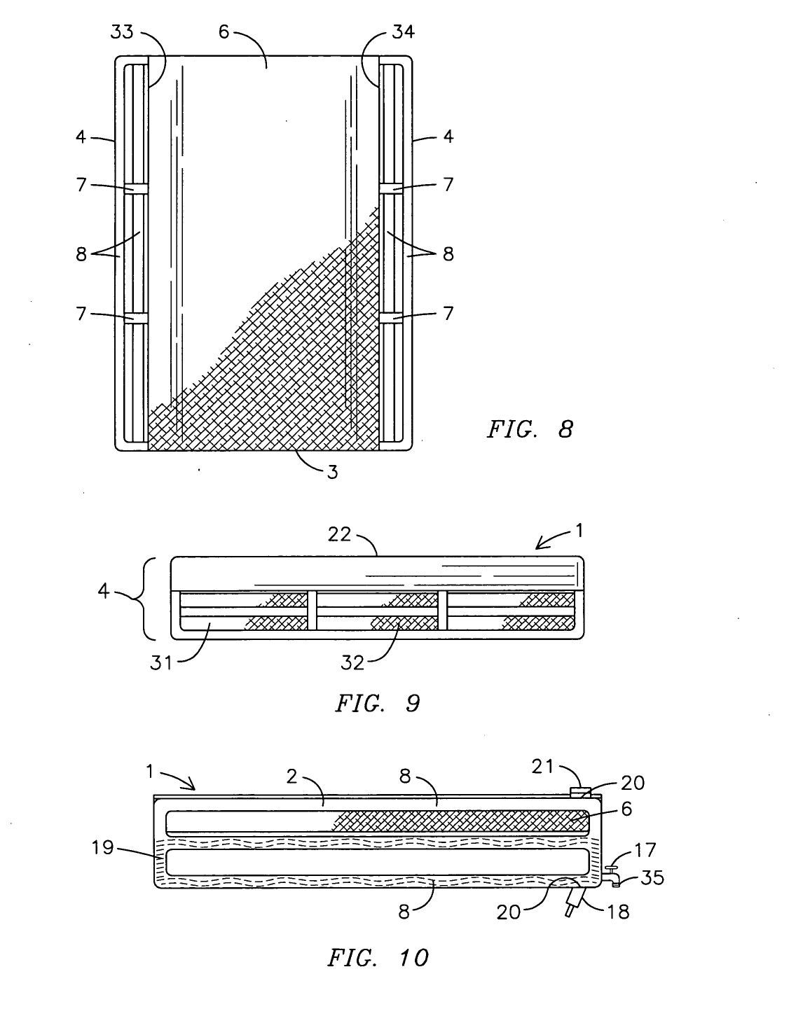

Next, FIG. 8 shows a top view of the truck bed animal enclosure device of the present invention. The covering 6 extends over the top section 3 of the frame 2 and may be detachable from the frame 2. The top section 3 includes a first edge 33 and an opposing second edge 34 that extend a substantial length of the truck bed 15. The side sections 4 are secured to the first and second edges 33 and 34 and extend towards the truck bed side panels 16 when secured to a truck bed 15.

Next, FIG. 9 shows a side plan view of an alternate embodiment of the truck bed animal enclosure device of the present invention. The alternate embodiment of the truck bed animal enclosure device 1 may include a hard top section 22 that is preferably permanently secured to the side sections 4 and back section 5 of the truck bed animal enclosure device 1 and is substantially planar and constructed of a solid section. Optional curtains 32 may also be installed on the side sections 4 so as to cover the apertures 31, which may be particularly useful during cold or rainy weather.

Finally, FIG. 10 shows a side plan view of a frame of the truck bed animal enclosure device of the present invention having an optional water feature. The frame 2, which is preferably hollow, may include an opening 20 located on a top horizontal bar 8 that permits a user to fill the frame 2 with a predetermined amount of water 19. A cap 21 is provided so as to cover the opening 20 when the user is not filling the frame 2. Another opening 20 may be located near a bottom horizontal bar 8 so as to provide access to the water 19 located within the frame 2. A water drinking means 18, which may be a spout, bottle or any other device, is in fluid communication with the water 19 within the frame 2 via the opening 20 located on the bottom horizontal bar 8 and is located on the interior of the frame 2 so as to permit animals within the truck bed 15 to drink water 19. A spigot 17 may be located on the exterior of the frame 2 so as to permit a user to drain the frame 2. In addition, the spigot 17 may include external threads 35 so as to permit a user to secure a hose thereon, which would be helpful in rinsing the animals prior to loading them in the truck bed 15.

The use of the present invention permit a person to safely enclose an animal within the confines of a truck bed.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A truck bed animal enclosure device comprising:
a frame having a top section with a first edge and a second edge, a side section secured to the top section first edge, a side section secured to the top section second edge and a back section pivotally secured to the top section via a hinging means;
said side sections extending a predetermined distance above a truck bed side panel;
said back section extending a predetermined distance above a truck bed tailgate;
said side sections having at least one aperture located therein;
a means for fastening the frame to a truck bed side panel;
a means for locking the back section to at least one side section; and
a covering extending a predetermined amount over the top section.

2. The truck bed animal enclosure device of claim 1 wherein:
said means for fastening the frame to a truck bed side panel is via at least one clamp that secures the side section to the truck bed side panel.

3. The truck bed animal enclosure device of claim 1 wherein:
said means for locking the back section to at least one side section is via at least one pin that is inserted into a hole extending through the at least one side section and through the back section.

4. The truck bed animal enclosure device of claim 2 wherein:
said means for locking the back section to at least one side section is via at least one pin that is inserted into a hole extending through the at least one side section and through the back section.

5. The truck bed animal enclosure device of claim 1 wherein:
said covering is a tarp.

6. The truck bed animal enclosure device of claim 3 wherein:
said covering is a tarp.

7. The truck bed animal enclosure device of claim 4 wherein:
said covering is a tarp.

8. The truck bed animal enclosure device of claim 1 wherein:
said frame is polyvinyl chloride pipe.

9. The truck bed animal enclosure device of claim 4 wherein:
said frame is polyvinyl chloride pipe.

10. The truck bed animal enclosure device of claim 7 wherein:
said frame is polyvinyl chloride pipe.

11. The truck bed animal enclosure device of claim 1 wherein:
said hinging means is at least one strap.

12. The truck bed animal enclosure device of claim 4 wherein:
said hinging means is at least one strap.

13. The truck bed animal enclosure device of claim 4 wherein:
said hinging means is at least one strap.

14. The truck bed animal enclosure device of claim 7 wherein:
said hinging means is at least one strap.

15. The truck bed animal enclosure device of claim 1 further comprising:
at least one curtain secured to at least one side section.

16. A truck bed animal enclosure device comprising:
a frame having a top section with a first edge and a second edge, a side section secured to the top section first edge at a predetermined angle, a side section secured to the top section second edge at a predetermined angle and a back section pivotally secured to the top section via a hinging means wherein said hinging means is at least one strap;
said frame is polyvinyl chloride pipe;
said side sections extending a predetermined distance above a truck bed side panel;
said back section extending a predetermined distance above a truck bed tailgate;
said side sections having at least one aperture located therein;
a means for fastening the frame to a truck bed side panel wherein said means for fastening the frame to a truck bed side panel is via at least one clamp that secures the side section to the truck bed side panel;
a means for locking the back section to at least one side section wherein said means for locking the back section to at least one side section is via at least one pin that is inserted into a hole extending through the at least one side section and through the back section; and
a covering extending a predetermined amount over the top section wherein said covering is a tarp.

17. A truck bed animal enclosure device comprising:
a frame having a top section with a first edge and a second edge, a side section secured to the top section first edge, a side section secured to the top section second edge and a back section pivotally secured to the top section via a hinging means;
said top section is a hard top section that is a substantially planar solid section;
said side sections extending a predetermined distance above a truck bed side panel;
said back section extending a predetermined distance above a truck bed tailgate;
said side sections having at least one aperture located therein;
a means for fastening the frame to a truck bed side panel; and
a means for locking the back section to at least one side section.

18. The truck bed animal enclosure device of claim 17 further comprising:
at least one hole located on the frame; and
at least one water drinking means secured to the frame.

19. The truck bed animal enclosure of claim 18 wherein:
said at least one water drinking means is a spout.

20. The truck bed animal enclosure of claim 18 further comprising:
at least one spigot located on said frame.
